(19) United States
(12) Patent Application Publication
(10) Pub. No.: US 2019/0076680 A1
(43) Pub. Date: Mar. 14, 2019

(54) MASK

(71) Applicants: BEIJING XIAOMI MOBILE SOFTWARE CO., LTD., Beijing (CN); BEIJING SMARTMI TECHNOLOGY CO., LTD., Beijing (CN)

(72) Inventors: Xiaolong LIU, Beijing (CN); Yang LIU, Beijing (CN); Ming GUO, Beijing (CN)

(73) Assignees: BEIJING XIAOMI MOBILE SOFTWARE CO., LTD., Beijing (CN); BEIJING SMARTMI TECHNOLOGY CO., LTD., Beijing (CN)

(21) Appl. No.: 16/128,528

(22) Filed: Sep. 12, 2018

(30) Foreign Application Priority Data
Sep. 13, 2017 (CN) 201710821355.0

(51) Int. Cl. A62B 23/02; A62B 9/04

(52) U.S. Cl. CPC A62B 23/025; A62B 9/04

(57) ABSTRACT

A mask includes a mask body and a support for supporting the mask body. The support includes a first sealing portion arranged on one end of the support and configured to be fitted to a nose of a user, and a second sealing portion arranged on the other end of the support and configured to be fitted to a lower jaw of the user.

### CROSS REFERENCE TO RELATED APPLICATIONS

This application claims priority to Chinese Patent Application No. 201710821355. 0 filed on Sep. 13, 2017, the entire content of which is incorporated herein by reference for all purposes.

### BACKGROUND

To achieve a protection effect, airtightness of a mask usually needs to be ensured first, that is, an edge of the mask may need to be fitted to a user face to prevent as much as possible ambient air from passing through a gap between the mask and the user face.

### SUMMARY

The present disclosure relates to a mask.

The mask may include: a mask body and a support for supporting the mask body; the support may include: a first sealing portion that is arranged on one end of the support and configured to be fitted to the nose of a user; and a second sealing portion that is arranged on the other end of the support and configured to be fitted to the lower jaw of the user.

It may be known from the above example that, in the present disclosure, the mask body may be more closely fitted to the face of the user since the mask body may be fitted to the nose and lower jaw of the user by arranging a support in the mask, thereby effectively improving airtightness of the mask.

It is to be understood that the above general description and the below detailed description are only illustrative and explanatory, and are not intended to limit the present disclosure.

The details of one or more embodiments of the subject matter described in the present disclosure are set forth in the accompanying drawings and description below. Other features, aspects, and advantages of the subject matter will become apparent from the description, the drawings, and the claims. Features of the present disclosure are illustrated by way of example and not limited in the following figures, in which like numerals indicate like elements.

### BRIEF DESCRIPTION OF THE DRAWINGS

The accompanying drawings herein incorporated in the specification constitute a part of the present description, provide illustrative examples consistent with the present disclosure, and serve to explain the principles of the present disclosure together with the description.

FIG. 1 is a schematic diagram illustrating a disposable mask according to some embodiments of the present disclosure.

FIG. 2 is a schematic diagram illustrating an outer side of a mask according to some embodiments of the present disclosure.

FIG. 3 is a schematic diagram illustrating an inner side of a mask according to some embodiments of the present disclosure.

FIG. 4 is a perspective view illustrating a support of a mask according to some embodiments of the present disclosure.

FIG. 5 is a top view illustrating the support shown in FIG. 4.

FIG. 6 is a side view illustrating the support shown in FIG. 4.

FIG. 7 is a perspective view illustrating a support according to some other embodiments of the present disclosure.

FIG. 8 is a perspective view illustrating the support shown in FIG. 7 in another direction.

FIG. 9 is a perspective view illustrating the support shown in FIG. 7 in yet another direction.

### DETAILED DESCRIPTION

Examples will be described in detail herein with the examples thereof expressed in the drawings. When the following descriptions involve the drawings, like numerals in different drawings represent like or similar elements unless stated otherwise. The implementations described in the following examples do not represent all implementations consistent with the present disclosure. On the contrary, they are examples of an apparatus and a method consistent with some aspects of the present disclosure described in detail in the appended claims.

The terminology used in the present disclosure is for the purpose of describing a particular example only, and is not intended to be limiting of the present disclosure. The singular forms such as “a,” “said,” and “the” used in the present disclosure and the appended claims are also intended to include multiple, unless the context clearly indicates otherwise. It is also to be understood that the term “and/or” as used herein refers to any or all possible combinations that include one or more associated listed items.

It is to be understood that although different information may be described using the terms such as first, second, third, etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “determining in response to.”

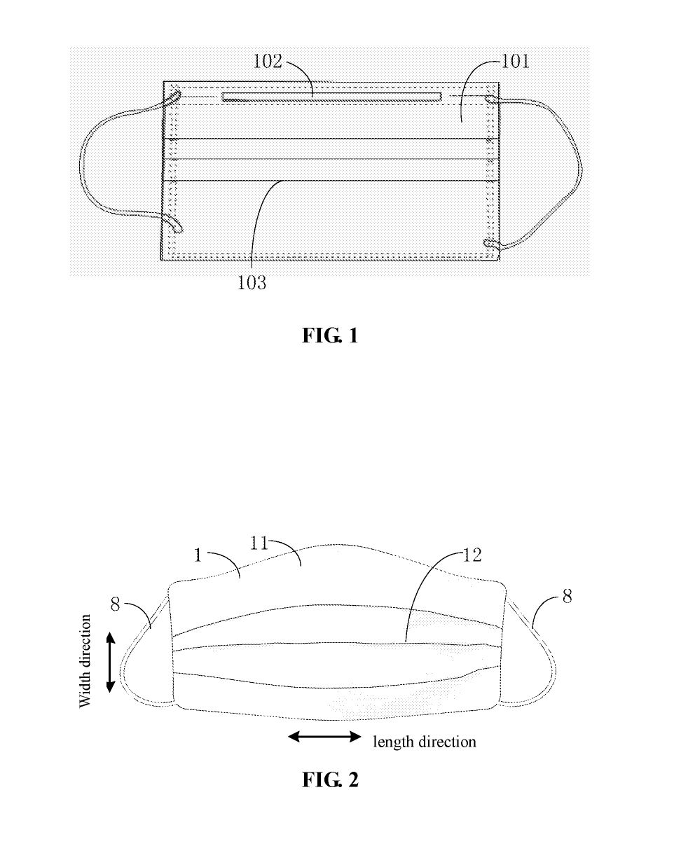

FIG. 1 is a schematic diagram illustrating a disposable mask. As shown in FIG. 1, a metal sheet 102 is arranged on the mask 101 at a position corresponding to a position of a nose bridge part so that the mask 101 may be adapted to a shape of a user's face, particularly to a shape of the nose bridge part by bending the metal sheet 102. Due to plasticity of the metal sheet 102, when being worn, the mask 101 may be deformed and may not tightly cover a mouth and a nose of the user as a result of facial movement and thus the airtightness may not be guaranteed. Further, after the mask 101 is worn, a creasing portion 103 may not be fully spread and consequently may contact the mouth and the nose. In particular, the mask 101 may closely contact the mouth and the nose during inhalation, thereby affecting comfort at use. In addition, gaps may still exist at other parts (for example, the lower jaw and the cheeks), if the metal sheet 102 is only arranged at the position corresponding to the nose bridge. Thus, the airtightness may be unsatisfactory.

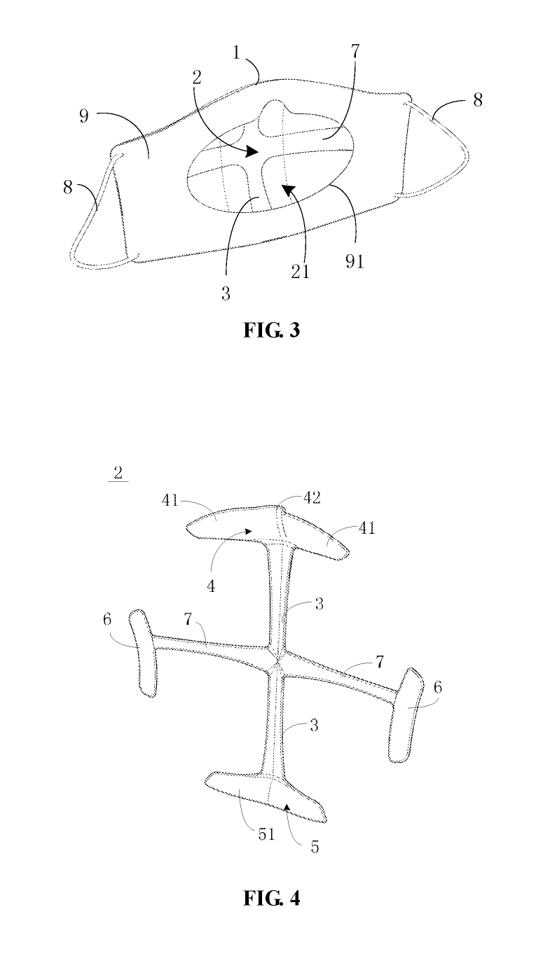

FIG. 2 and FIG. 3 are schematic diagrams illustrating an outer side and an inner side of a mask according to some embodiments of the present disclosure. FIG. 4 is a perspective view illustrating a support shown in FIG. 2 and FIG. 3 according to some embodiments of the present disclosure. As shown in FIGS. 2-4, a mask of the present disclosure may include a mask body 1 and a support 2, where the support 2 is used to support the mask body 1 so that the mask body 1 may be fitted to a face of a user better. The “being fitted to” in the present disclosure may refer to that a component and the face of the user may be directly fitted, and may also be indirectly fitted, for example, a face contacting layer may be provided between the component and the face of the user. In this way, the mask may have fine airtightness.

The mask may be a disposable mask for daily use or a mask for industrial purpose. The mask body 1 may include an outer cover 11, a filtering portion (not shown) and attachment straps 8 that are connected on both sides of the outer cover 11 and may be attached to ears of the user. The filtering portion is configured to filter air and may be arranged by one side of the outer cover 11 facing the face of the user. All or part of the filtering portion and the outer cover 11 may be folded along a length direction shown in FIG. 2 to form a folding portion 12. The support 2 may unfold the folding portion 12 along a width direction of the mask body 1. The outer cover 11 with good air permeability may be made of an ordinary textile fabric of a common mask, a non-woven fabric, a melt-blown or electrostatic filter material with a particular filtering efficiency, an anti-bacterial material, and the like. The filtering portion may be a filter element made of a common filter material, or may be integrated with the outer cover 11.

The support 2 may be made of a bendable lightweight material with elasticity and toughness, for example, plastic, so that the support 2 may be elastically deformed in use. The support 2 may include a body portion 3, where two ends of the body portion 3 along the width direction of the mask body 1 shown in FIG. 2 may be provided with a first sealing portion 4 and a second sealing portion 5, respectively. In some embodiments shown in FIG. 4, the first sealing portion 4 may include a matching portion 42 matched with a shape of the nose of the user, and first fitting portions 41 connected with the matching portion 42. The matching portion 42 may be of an arc shape. The first fitting portions 41 may be arranged on both sides of the matching portion 42, and may bend toward the face of the user to be fitted to shapes of both sides of the nose of the user. The second sealing portion 5 may include a first undulating portion 51 fitted to a lower jaw of the user. Both ends of the first undulating portion 51 may bend toward the face of the user. The first undulating portion 51 may be similar to the first fitting portions 41 in shape.

Both the first sealing portion 4 and the second sealing portion 5 may be arc-shaped to be fitted to the face of the user, thereby improving airtightness of the mask. In this example, the first sealing portion 4 is configured to be fitted to the nose of the user for sealing up a gap between the mask body 1 and the nose of the user and gaps between the mask body 1 and both sides of the nose of the user. The second sealing portion 5 is configured to be fitted to the lower jaw of the user for sealing up a gap between the mask body 1 and the lower jaw of the user. Length directions of the first sealing portion 4 and the second sealing portion 5 are both consistent with the length direction of the mask body 1, and a shape similar to a shape of transverse “H” may be formed after the first sealing portion 4 and the second sealing portion 5 are connected with the body portion 3.

All or part of the body portion 3 protrudes away from the face of the user, so that part of the mask body 1 stays away from the user to form an air change space 21. The body portion 3 may be substantially C-shaped, or may be bent into a roughly C shape in use. The body portion 3 is arranged in the mask body 1 for supporting the outer cover 11 and the filtering portion, and the formed air change space 21 may accommodate the mouth and the nose of the user. When the mask is used, breathing resistance may be reduced since the mask body 1 may not closely contact the mouth and the nose of the user. Meanwhile, since the first sealing portion 4 and the second sealing portion 5 are arranged on ends of the body portion 3 and both ends of the body portion 3 are closely fitted to the face of the user, one side of the mask body 1 facing the user may be better fitted to the nose and the lower jaw of the user with the assistance of the first sealing portion 4 and the second sealing portion 5, thereby effectively improving the airtightness of the mask.

A length of the support 2 along the width direction of the mask may be equal to or slightly longer than a width of the mask body 1. As shown in FIGS. 2-4, the first sealing portion 4 and the second sealing portion 5 after being connected by the body portion 3 may be used to support the mask body 1 and may also stretch the mask body 1 so that a part of the mask body 1 corresponding to the nose and the lower jaw of the user is relatively longer than the rest part of the mask body 1 along the width direction. In this way, on one hand, the mask body 1 may be fitted to the nose and the lower jaw of the user better, and on the other hand, the folding portion 12 may be unfolded to effectively increase an effective filtering area of the mask. Therefore, a folding interval of the folding portion 12 may be smaller than a folding interval of a general mask. For example, an interval of about 5 mm may be adopted to increase the number of folds. An effect of increasing the filtering area of the mask may be achieved when the folding portion 12 is unfolded by the support 2.

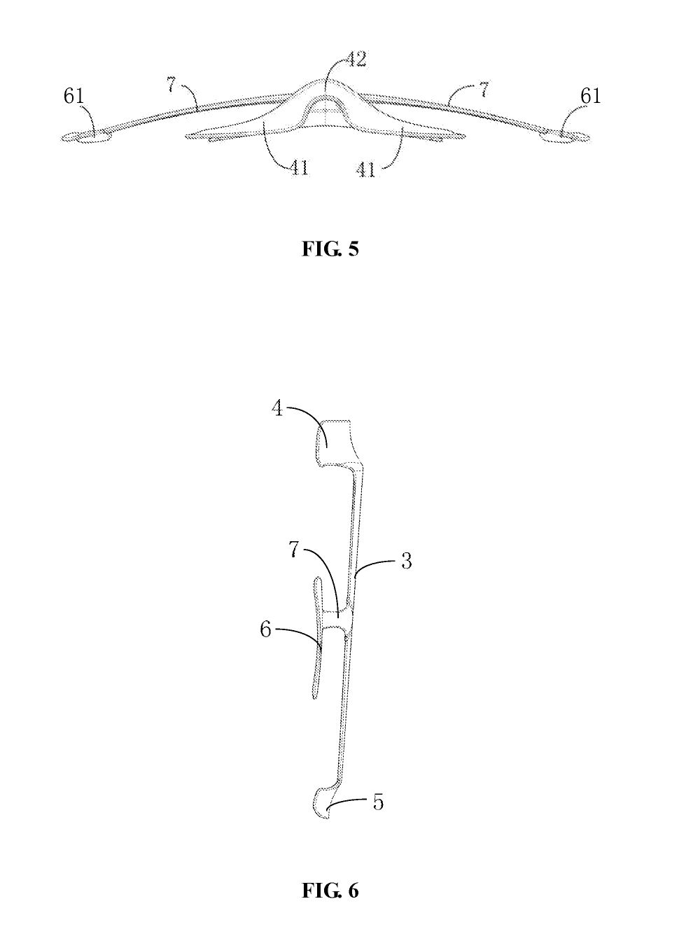

FIG. 5 is a top view illustrating the support 2 shown in FIG. 4. FIG. 6 is a right view illustrating the support 2 shown in FIG. 4. As shown in FIGS. 4-6, the support 2 may also include two third sealing portions 6 arranged on both ends of the mask body 1 along the length direction. The third sealing portions 6 may be fitted to at least part of cheeks of the user (part of the face except for the nose and the lower jaw) to seal up gaps between the mask body 1 and the cheeks of the user, thereby further improving the airtightness of the mask.

The third sealing portions 6 may be similar to the second sealing portion 5 in shape, and may also be configured with second undulating portions 61. Both ends of the third sealing portions 6 may bend toward the face of the user to be fitted to the cheeks of the user better. In some embodiments, the two third sealing portions 6 may be connected with the body portion 3 through two support ribs 7. An end of the support ribs 7 connected with the third sealing portions 6 may bend toward the face of the user so as to achieve an effect shown in FIG. 3. The support ribs 7 and the body portion 3 enclose the air change space 21. Meanwhile, the two third sealing portions 6 may be fitted to the cheeks of the user better with the support ribs 7, thereby increasing airtightness. In some embodiments, the support ribs 7 may be made of plastic.

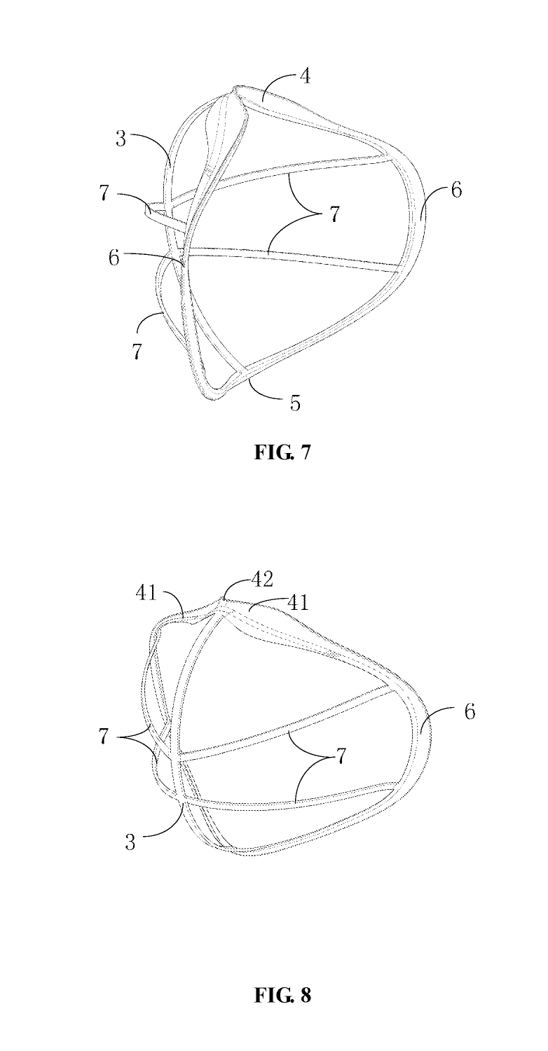

The nose, the lower jaw and the cheeks of the user may be deformed due to movement of muscles when the user talks, laughs, etc., and therefore a gap may be generated between the user and the mask to allow air to pass through the gap, thereby affecting the airtightness of the mask. As shown in FIGS. 4-6, the two third sealing portions 6 extend along the width direction of the mask body 1, the first sealing portion 4 and the second sealing portion 5 extend along the length direction of the mask body 1, and the support ribs 7 connecting the two third sealing portions 6 may form a cross with the body portion 3. When the mask is being used, the attachment straps 8 are attached to ears of the user, consequently, the first sealing portion 4, the second sealing portion 5 and the third sealing portions 6 may be closely fitted to the face of the user. Therefore, the airtightness of the mask at four positions through which the air easily passes may be effectively improved. Certainly, the two third sealing portions 6 may also form a cup shape with the body portion 3 to effectively accommodate an activity region of the mouth of the user, which is detailed in FIGS. 7-9.

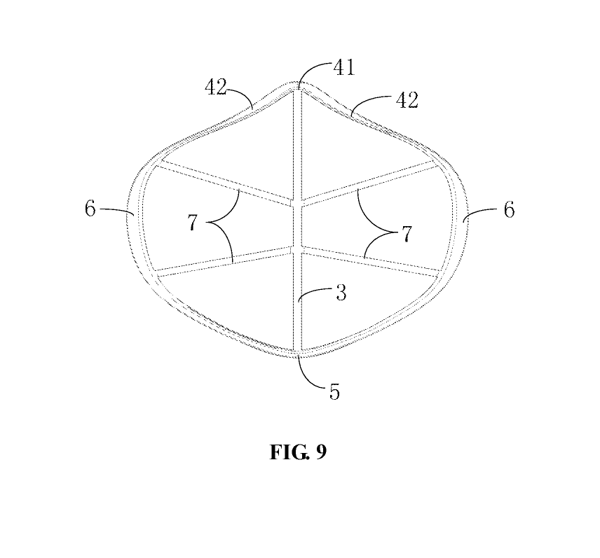

FIG. 7 and FIG. 8 are perspective views illustrating a support 2 in another example of the present disclosure. FIG. 9 is a schematic diagram illustrating the support viewed from a user direction. In this example, the third sealing portions 6, the first sealing portion 4 and the second sealing portion 5 may be an integral structure. The integral structure may be circular, and each part of the structure may be fitted to the face of a user. Certainly, the integral structure may also be integrated with the body portion 3 and the support ribs 7 by an injection moulding process, or the like. An edge (a periphery of the mask body 1 in a direction shown in FIG. 3) of the mask body 1 facing the user may be fitted to the face of the user by the combination of the integral structure with the mask body 1.

In this example, as shown in FIG. 9, the sealing portion 4 includes a matching portion 42 matched with a shape of the nose of the user and two first fitting portions 41 connected with the matching portion 42. The matching portion 42 may be arc-shaped to be matched with the nose of the user. The first fitting portions 41 may be arranged on both sides of the matching portion 42, and may bend toward the user to be matched with the shapes of both sides of the nose of the user. Further, the two first fitting portions 41 are connected with one end of the two third sealing portions 6 respectively, and the other end of the two third sealing portions 6 is connected with the second sealing portion 5, respectively. Each of the third sealing portions 6 is connected with the body portion 3 through two support ribs 7, respectively. The first sealing portion 4, the second sealing portion 5 and the third sealing portions 6 enclose the air change space 21 together with the body portion 3.

To further increase the airtightness of the mask, as shown in FIG. 3, the mask may also include a face contacting layer 9 connected with an edge of the mask body 1 facing the face of the user based on the above two examples. The support 2 is positioned between the face contacting layer 9 and the mask body 1. The face contacting layer 9 may be made of an impermeable and skin-friendly soft material, for example, a polyethylene material or a composite material of polyester and polyurethane. When the mask is being used, the face contacting layer 9 may be in good contact with the face of the user, and may be deformed along with changes of facial muscles of the user to match a shape of the face of the user. In order to avoid hindering the nose and the mouth of the user, the face contacting layer 9 may be formed by fixing a strip (with a particular width) of the above materials around the outer edge of the mask body 1. Alternatively, an opening portion 91 matched with the nose and the mouth of the user is opened on the face contacting layer 9 and the user may put the mouth and the nose in the air change space 21 from the opening portion 91 when using the mask. With a combination of the support 2 and the face contacting layer 91, influence of differences in shapes of human faces on the protection effect of the mask may be reduced to some extent, thereby improving the airtightness of the mask.

Further, a position that is on the mask body 1 and corresponds to the nose and/or the lower jaw of the user may also be provided with at least one of the following auxiliary pieces: a sealing strip made of a flexible material such as a metal plastic strip or a sponge. In some embodiments, the mask body 1 may include at least one of a first sealing auxiliary piece corresponding to the first sealing portion 4 and a second sealing auxiliary piece corresponding to the second sealing portion 5. The first sealing auxiliary piece and the second sealing auxiliary piece may be made of any one of a plastic metal and a flexible material.

It may be seen from the above technical solution that the airtightness of the mask may be well improved by turning key positions that affect the airtightness fitted to the shape of the face of user; further, the filtering area of the mask may be effectively increased by supporting and spreading the creasing portion by the support, thereby effectively improving wearing comfort of the mask. The support 2 may be arranged in a simple and convenient manner and therefore optimizing external appearance of the mask to some extent.

The combination of the support 2 and the inner face-contacting layer 9 may reduce the influence of the differences in shapes of human faces on the protection effect of the mask, thereby further improving the airtightness of the mask.

After considering the specification and practicing the present disclosure, those of ordinary skill in the prior art may easily conceive of other implementations of the present disclosure. The present disclosure is intended to include any variations, uses and adaptive changes of the present disclosure. These variations, uses and adaptive changes follow the general principle of the present disclosure and include common knowledge or conventional technical means in the prior art not disclosed in the present disclosure. The specification and examples herein are intended to be illustrative only and the real scope and spirit of the present disclosure are indicated by the claims of the present disclosure.

It is to be understood that the present disclosure is not limited to the precise structures described above and shown in the accompanying drawings and may be modified or changed without departing from the scope of the present disclosure.

1. A mask, comprising:
a mask body; and
a support configured to support the mask body, comprising:
a first sealing portion arranged on one end of the support and configured to be fitted to a nose of a user; and
a second sealing portion arranged on another end of the support and configured to be fitted to a lower jaw of the user.

2. The mask of claim 1, wherein the first sealing portion comprises:
a matching portion matched with a shape of the nose of the user, and
two first fitting portions connected with the matching portion,
wherein the two first fitting portions are arranged on both sides of the matching portion and are matched with shapes of both sides of the nose of the user.

3. The mask of claim 1, wherein
the second sealing portion comprises a first undulating portion fitted to the lower jaw of the user, and
both ends of the first undulating portion bend toward a face of the user.

4. The mask of claim 1, wherein:
the support further comprises a body portion for connecting the first sealing portion and the second sealing portion, and
at least part of the body portion protrudes away from the face of the user.

5. The mask of claim 1, wherein
the mask body comprises a folding portion formed by folding at least part of the mask body, and
the support is capable of unfolding the folding portion along a width direction of the mask body.

6. The mask of claim 4, wherein:
the support further comprises two third sealing portions arranged on both sides of the mask body along a length direction, and
the two third sealing portions are fitted to at least part of cheeks of the user.

7. The mask of claim 6, wherein:
the third sealing portions are connected with the body portion through support ribs, and
ends of the support ribs connected with the third sealing portions bend toward the face of the user.

8. The mask of claim 7, wherein the support ribs are made of plastic.

9. The mask of claim 6, wherein the first sealing portion is connected with the second sealing portion through the third sealing portions.

10. The mask of claim 6, wherein:
the two third sealing portions extend along a width direction of the mask body, and
the first sealing portion and the second sealing portion extend along the length direction of the mask body.

11. The mask of claim 6, wherein a line connecting the two third sealing portions forms a cross shape with the body portion.

12. The mask of claim 6, wherein:
the third sealing portion comprises a second undulating portion configured to be fitted to the cheeks of the user, and
both ends of the second undulating portion bend toward the face of the user.

13. The mask of claim 1, wherein the mask body comprises:
an outer cover, and
a filtering portion arranged by one side of the outer cover facing the face of the user.

14. The mask of claim 1, further comprising:
a face contacting layer connected with an edge of the mask body facing the face of the user, and
the support is positioned between the face contacting layer and the mask body.

15. The mask of claim 14, wherein the face contacting layer is provided with an opening portion matched with the mouth and the nose of the user.

16. The mask of claim 14, wherein the face contacting layer is made of an impermeable soft material.

17. The mask of claim 14, wherein materials for preparing the face contacting layer comprise at least one of the following materials:
a polyethylene material, and
a composite material of polyester and polyurethane.

18. The mask of claim 1, wherein the support is made of plastic.

19. The mask of claim 1, wherein the mask body comprises at least one of following auxiliary pieces:
a first sealing auxiliary piece corresponding to the first sealing portion; or
a second sealing auxiliary piece corresponding to the second sealing portion.

20. The mask of claim 19, wherein the first sealing auxiliary piece and the second sealing auxiliary piece are made of at least one of:
a plastic metal, or
a flexible material.
